(19) United States
(12) Patent Application Publication
(10) Pub. No.: US 2023/0074842 A1
(43) Pub. Date: Mar. 9, 2023

(54) THERMOMETER FOR A ROTISSERIE

(71) Applicant: Onward Multi-Corp Inc., Walerloo (CA)

(72) Inventors: Kiel Webb, Waterloo (CA); Benjamin Harrison, Waterloo (CA); Colin Kirvan, Waterloo (CA); Theodore Andrew Witzel, Waterloo (CA)

(21) Appl. No.: 17/865,524

(22) Filed: Jul. 15, 2022

Related U.S. Application Data
(60) Provisional application No. 63/222,281, filed on Jul. 15, 2021.

(51) Int. Cl. G01K 1/024; G01K 1/02

(52) U.S. Cl. CPC G01K 1/024; G01K 1/026; G01K 2207/06

(57) ABSTRACT

A thermometer for a rotisserie having a temperature sensor for measuring a temperature of food in a cookbox, a base station for receiving the measured temperature of the food from the temperature sensor, and a shaft body having a first portion for supporting the base station exterior to the cookbox and a second portion receivable within the cookbox. The shaft body defines a channel passing between the first portion and the second portion for receiving a temperature sensor wire therein such that the temperature sensor in the cookbox can be electrically coupled to the base station.

### CROSS-REFERENCE TO RELATED PATENT APPLICATIONS

This application claims priority from U.S. Provisional Patent Application No. 63/222,281, filed on Jul. 15, 2021. The entire contents of U.S. Provisional Patent Application No. 63/222,281 is herein incorporated by reference for all purposes.

### FIELD

The systems and methods disclosed herein generally relate to the field of thermometers and in particular to thermometers for rotisseries.

### INTRODUCTION

The measuring of food temperature in a cookbox provides a user with the ability to determine whether the food has been safely cooked. However, measuring the temperature of food on a rotisserie in the cookbox provides the difficulty of measuring a moving item. The use of a wired thermometer may result in the wire becoming tangled or interfering with the rotation of the rotisserie. Wireless thermometers may be used in the cookbox, but the signal emitted from the wireless thermometer may be interfered with by the heat and lid of the cookbox.

### SUMMARY OF VARIOUS EMBODIMENTS

This summary is intended to introduce the reader to the more detailed description that follows and not to limit or define any claimed or as yet unclaimed invention. One or more inventions may reside in any combination or sub-combination of the elements or process steps disclosed in any part of this document including its claims and figures.

In one aspect, a thermometer is provided having:

a temperature sensor for measuring a temperature of food in a cookbox;

a base station for receiving the measured temperature of the food from the temperature sensor; and

a shaft body having a first portion for supporting the base station exterior to the cookbox and a second portion receivable within the cookbox,

the shaft body defining a channel passing between the first portion and the second portion for receiving a temperature sensor wire therein such that the temperature sensor in the cookbox can be electrically coupled to the base station.

In any embodiment, at least a portion of the channel may be enclosed.

In any embodiment, the shaft body may have a collar and the collar may enclose the enclosed portion of the channel.

In any embodiment, the first portion may have a first opening for receiving the temperature sensor wire, the first opening being connected to the channel.

In any embodiment, the shaft body may have a longitudinal axis and a projection of the longitudinal axis may pass through the first opening.

In any embodiment, the second portion may have a second opening for receiving the temperature sensor wire, the second opening being connected to the channel.

In any embodiment, the shaft body may have a longitudinal axis and radial axis that is perpendicular to the longitudinal axis and a projection of the radial axis may pass through the second opening.

In any embodiment, the channel may extend along a longitudinal axis of the shaft body.

In any embodiment, the thermometer may further include a winding member located proximate the first portion for storing at least a portion of the temperature sensor wire.

In any embodiment, the base station may have a readout for displaying the measured temperature of the food.

In any embodiment, the readout may be a display.

In any embodiment, the readout may be self-leveling.

In any embodiment, the base station may further include a wireless communications module for communicating with a wireless communications device.

In any embodiment, the wireless communications module may operate on one or more of Bluetooth, Wi-Fi, RFID, or NFC.

In any embodiment, the temperature sensor may be a first temperature sensor and the measured temperature may be a first measured temperature and the thermometer may further include at least a second temperature sensor for measuring a second temperature of the food.

In any embodiment, the display may have a first display for displaying the first measured temperature and a second display for displaying the second measured temperature.

In any embodiment, the thermometer may further comprise a third temperature sensor for measuring a third temperature of the food and a fourth temperature sensor for measuring a fourth temperature of the food.

In any embodiment, the display may alternately display one or more of the first temperature, the second temperature, the third temperature, and the fourth temperature.

In any embodiment, the second portion may be couplable to the rotisserie and when the second portion is coupled to the rotisserie the shaft body may rotate with rotation of the rotisserie.

In any embodiment, when the temperature sensor wire is positioned in the channel and the rotisserie is rotated, the temperature sensor wire may remain positioned within the channel.

In any embodiment, the shaft body may have a notch for receiving a lid of the cookbox.

In any embodiment, the temperature sensor may be a probe that is sized and shaped to be inserted into the food.

In any embodiment, the channel may have a first port for electrically coupling to the base station, a second port for electrically coupling to the temperature sensor, and an internal circuit for electrically connecting the first port to the second port.

In another aspect, there is provided a shaft adaptor for a cookbox rotisserie having:

a shaft body having a first portion for supporting a base station exterior to the cookbox and a second portion receivable within the cookbox,
wherein the shaft body defines a channel passing between the first portion and the second portion for receiving a temperature sensor wire therein such that a temperature sensor in the cookbox can be electrically coupled to the base station.

These and other aspects and features of various embodiments will be described in greater detail below.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 shows a perspective view of a cookbox with a rotisserie and a thermometer in accordance with an embodiment described herein;

FIG. 2 shows a perspective close-up view of the cookbox of FIG. 1;

FIG. 3 shows a front perspective view of the thermometer of FIG. 1;

FIG. 4 shows a front view of the thermometer of FIG. 1;

FIG. 5A shows a top view of the thermometer of FIG. 1;

FIG. 5B shows a cross-sectional view of the thermometer of FIG. 1 along the line 5-5 in FIG. 5A;

FIG. 6 shows a cross-sectional view of the thermometer of FIG. 1 along the line 5-5 of FIG. 5A;

FIG. 7 shows a front perspective view of the cookbox of FIG. 1;

FIG. 8 shows a front perspective view of the thermometer of FIG. 1;

FIG. 9 shows a cross-sectional view of the thermometer of FIG. 1 installed in the cookbox, along the line 5-5 in FIG. 5A;

FIG. 10A shows a front perspective view of a thermometer in accordance with another embodiment described herein;

FIG. 10B shows a cross-sectional view of the thermometer of FIG. 10A along the line 10-10 in FIG. 10A;

FIG. 10C shows a front view of the thermometer of FIG. 10A;

FIG. 11 shows a perspective view of a cookbox with a rotisserie and a thermometer in accordance with another embodiment described herein;

FIG. 12 shows a side view of the thermometer of FIG. 11;

FIG. 13A shows a front perspective view of the thermometer of FIG. 11;

FIG. 13B shows a front view of the thermometer of FIG. 11;

FIG. 13C shows a partial side view of the thermometer of FIG. 11;

FIG. 14A shows a top view of the thermometer of FIG. 11;

FIG. 14B shows a side cross-sectional view of the thermometer of FIG. 11, along the line 14-14 in FIG. 14A;

FIG. 15 shows a side cross-sectional view of the thermometer of FIG. 11, along the line 14-14 in FIG. 14A;

FIG. 16A shows a front perspective view of a base station in accordance with another embodiment described herein;

FIG. 16B shows a rear perspective view of the base station of FIG. 16A;

FIGS. 17A-17C show a front view of the base station of FIG. 16A in various rotational positions; and

FIG. 18 shows the base station of FIG. 16A with different temperature readouts.

### DETAILED DESCRIPTION OF THE EMBODIMENTS

Various systems, devices or methods will be described below to provide an example of at least one embodiment of the claimed subject matter. No embodiment described herein limits any claimed subject matter and any claimed subject matter may cover systems, devices or methods that differ from those described herein. The claimed subject matter is not limited to systems, devices or methods having all of the features of any one process or device described below or to features common to multiple or all of the systems, devices or methods described herein. It is possible that a system, device or method described herein is not an embodiment of any claimed subject matter. Any subject matter that is disclosed in a system, device or method described herein that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two or more elements or devices can be directly connected to one another or connected to one another through one or more intermediate elements or devices via an electrical element, electrical signal or a mechanical element depending on the particular context.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 10%, for example.

In accordance with the teachings herein, at least one embodiment is provided for a thermometer for a rotisserie. It should be appreciated that the systems and methods for measuring the temperature of food described herein are for use with any rotatable cooking device.

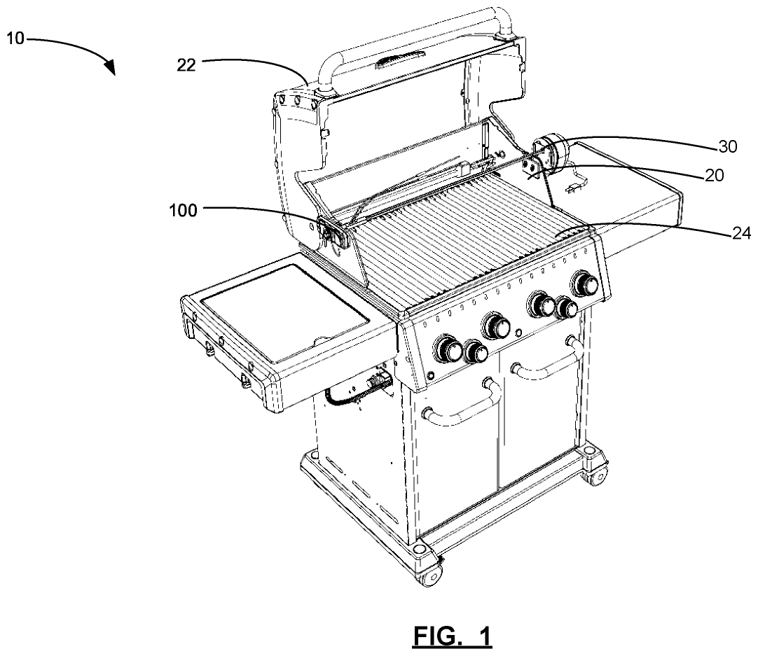

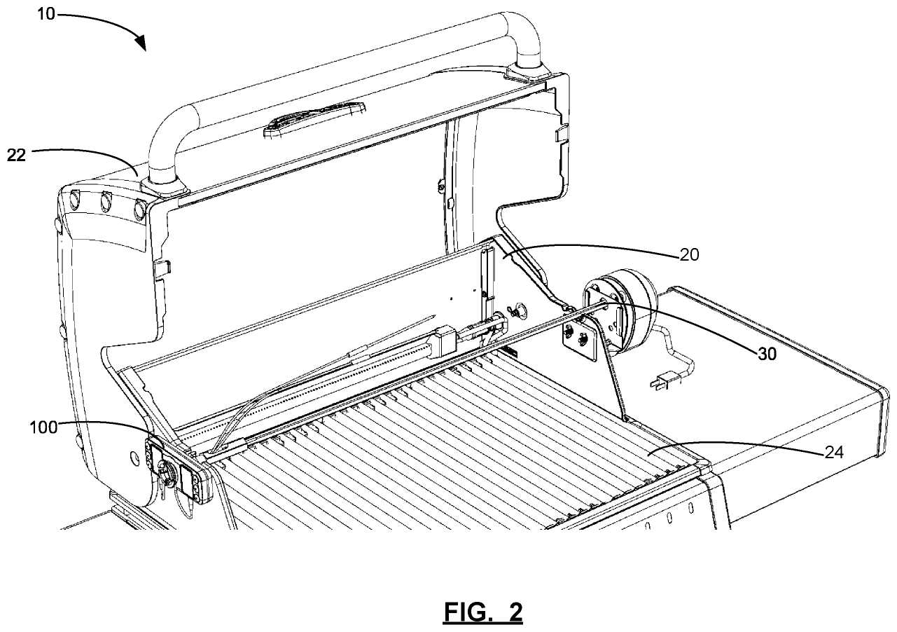

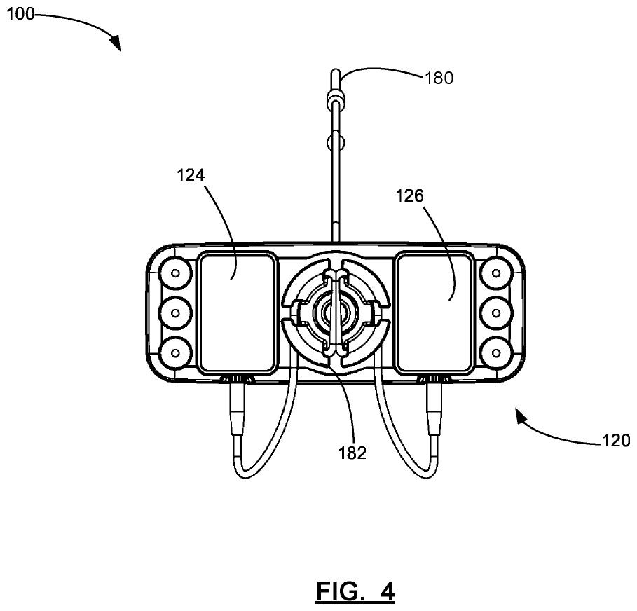

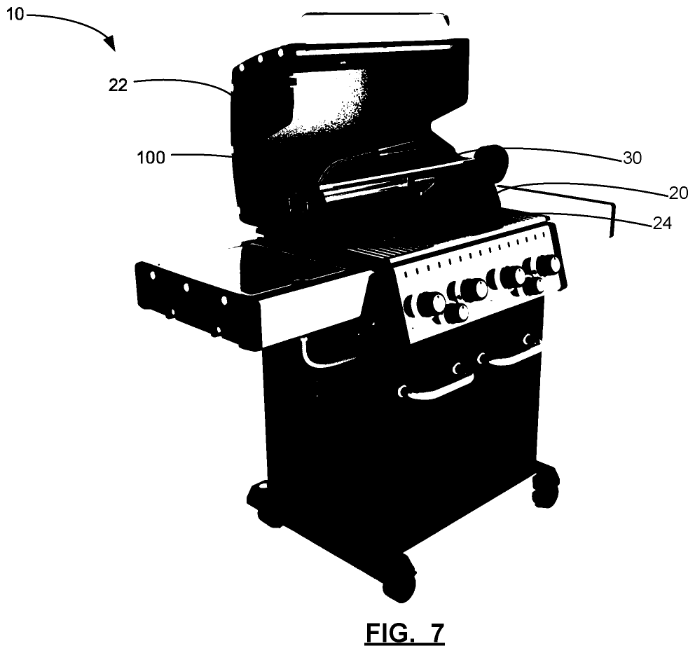

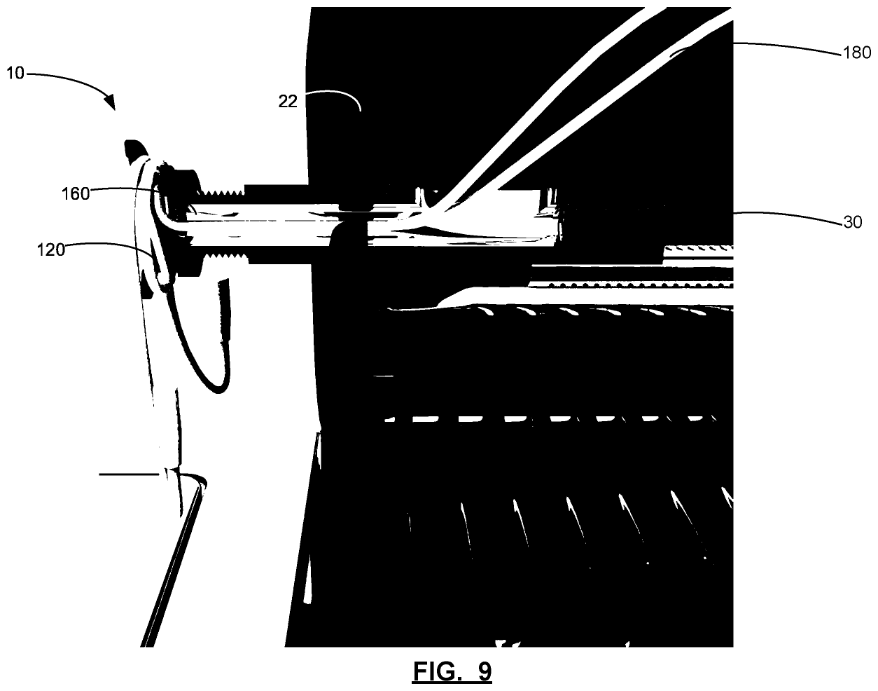

Referring to FIGS. 1 and 2, shown therein is a barbeque 10 having a cookbox 20. The cookbox has a lid 22 and a grill 24. Referring to FIGS. 1 to 9, shown therein is an exemplary embodiment of a thermometer 100. As exemplified, the thermometer 100 is coupled to a rotisserie 30 positioned on the barbeque 10. The thermometer 100 has a base station 120, a temperature sensor 140, and a shaft body 160. The shaft body 160 has a first portion 162 for supporting the base station 120 exterior to the cookbox 20 and a second portion 164 receivable within the cookbox 20. The shaft body 160 receives a wire 180 that electrically couples the temperature sensor 140 to the base station 120. As shown, the base station 120 is positioned exterior to the cookbox 20, the temperature sensor 140 is positioned interior to the cookbox 20, and the shaft body 160 extends from interior to the cookbox 20 to exterior to the cookbox 20. The shaft body 160 may also be referred to as a shaft adaptor for adapting the rotisserie 30 to receive a base station 120 and a temperature sensor 140.

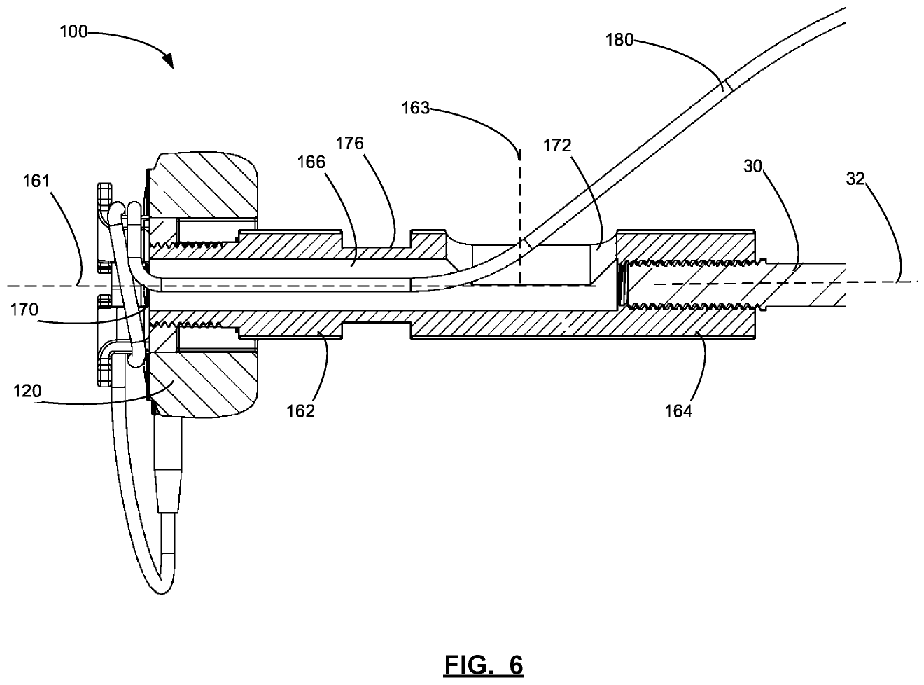

As exemplified in FIG. 6, the shaft body 160 defines a channel 166 that passes between the first portion 162 and the second portion 164 for receiving a temperature sensor wire 180 therein. The temperature sensor wire 180 is used to electrically couple the temperature sensor 140 in the cookbox 20 to the base station 120 exterior to the cookbox 20. While it is possible to use a wireless connection between the temperature sensor 140 and the base station 120, there are difficulties associated with this wireless connection. For example, the wireless signal between the base station 120 and the temperature sensor 140 may be interfered with by the cookbox 20 enclosure and/or the high heat within the cookbox 20. Thus, it is desirous to use a connection to prevent interference between the temperature sensor 140 and the base station 120. Accordingly, an advantage of this design is that there is a hardwired connection between the temperature sensor 140 within the cookbox 20 and the base station 120 exterior to the cookbox 20. This hardwired connection may provide a stable electrical connection between the base station 120 exterior to the cookbox 20 and the temperature sensor 140 within the cookbox 20.

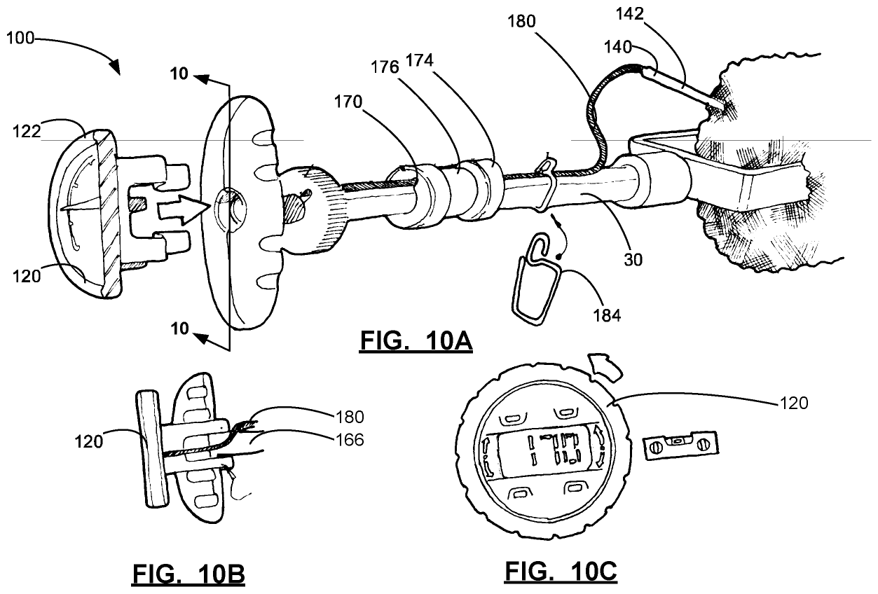

Typically, the use of a wired connection from interior to the cookbox 20 to exterior to the cookbox 20, in combination with a rotisserie 30, results in tangling of the wire 180 and/or the rotation of the rotisserie 30 being disrupted. An advantage of thermometer 100 is that the channel 166 provides a path for the wire 180 to travel from within the cookbox 20 to exterior to the cookbox 20, without interfering with the rotation of the rotisserie 30 or causing damage to the wire 180 and/or thermometer 100. For example, as the shaft body 160 rotates with rotation of the rotisserie 30, the wire 180 may remain positioned within the channel 166, thereby preventing entanglement. In some embodiments, one or more clips 184 may be used to additional secure the wire 180, as exemplified in FIG. 10A.

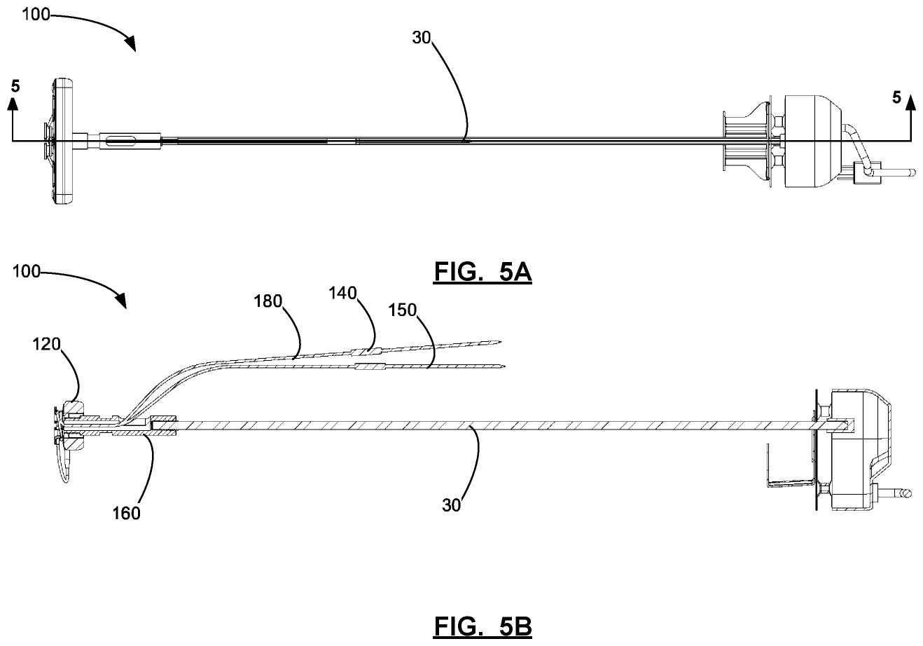

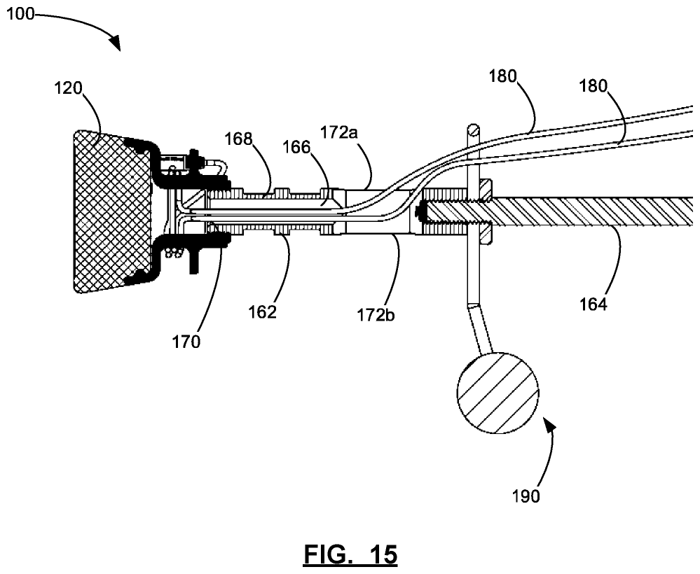

Referring to FIGS. 5B, 6, and 15 as exemplified, the channel 166 provides a passage for the wire 180 to pass from the interior of the cookbox 20 to the exterior of the cookbox 20. Positioning the wire 180 in the channel 166 may prevent tangling of the wire 180 and allow the wire 180 to electrically connect the temperature sensor 140 to the base station 120. The channel 166 may be any size and or/shape that allows the wire 180 to pass from the interior of the cookbox 20 to the exterior of the cookbox 20. For example, in some embodiments, at least a portion of the channel 166 may be enclosed. As exemplified in FIGS. 5B, 6, and 15 the channel 166 has an enclosed portion 168. As shown, the first portion 162 has a first opening 170 connected to the channel 166. Similarly, as shown, the second portion 164 has a second opening 172 connected to the channel 166. In other words, the enclosed portion 168 extends from the first opening 170 to the second opening 172. Accordingly, as exemplified in FIGS. 6 and 15, the wire 180 may pass from the base station 120 through the first opening 170 in the first portion 162 located exterior to the cookbox 20, through the channel 166, and out of the second opening 172 in the second portion 164 to the temperature sensor 140 interior of the cookbox 20. In some embodiments, as exemplified in FIG. 10A, the shaft body 160 may have a collar 174 and the collar may provide the enclosed portion 168 of the channel 166.

In some embodiments, the thermometer 100 may have a plurality of second openings 172. As exemplified in FIG. 15, the second portion 164 has a second opening 172a and a second opening 172b. The second openings 172a and 172b are radially opposed to each other. Providing two second openings 172a, 172b may allow for improved versatility when running the wire 180 from the cookbox 20 to the base station 120, thereby reducing the likelihood of entanglement of the wire 180.

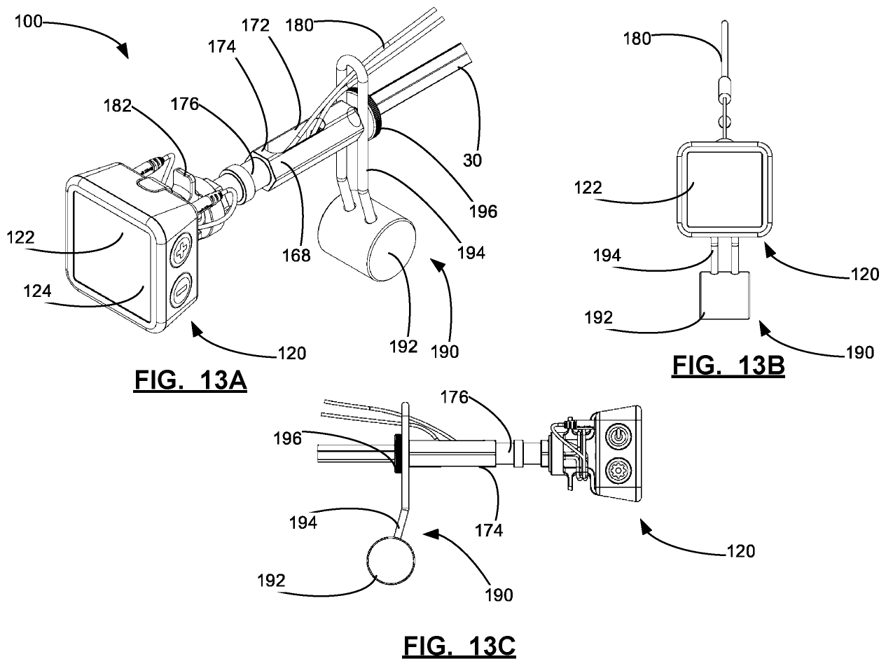

In some embodiments, as exemplified in FIGS. 6, 10, and 13A the shaft body 160 may have a notch 176 for receiving the lid of the cookbox 20. The notch 176 may allow the lid 22 to be recessed into the shaft body 160, thereby providing for a better seal between the shaft body 160 and the cookbox 20. An improved seal between the lid 22 and the shaft body 160 may reduce thermal leakage from within the cookbox 20.

The orientation of the channel 166 may be aligned with an axis of rotation 32 of the rotisserie 30. For example, the shaft body 160 has a longitudinal axis 161 along the axis of rotation 32 and a radial axis 163 that is perpendicular to the longitudinal axis 161. As exemplified in FIGS. 5B and 6, the channel 166 extends along the longitudinal axis 161 of the shaft body 160. Aligning the channel 166 with the longitudinal axis 161 may reduce the likelihood of the wire 180 in the channel 166 becoming tangled.

The position of the first opening 170 may vary. As exemplified in FIGS. 5B and 6, a projection of the longitudinal axis 161 of the shaft body 160 passes through the first opening 170. An advantage of this design is that, as the shaft body 160 rotates with the rotisserie 30, the rotation of the wire 180 is along the rotation axis of the rotisserie 30. In other words, the at least a portion of the wire 180 may be generally colinear with the axis of rotation 32 of the rotisserie 30, which may prevent radial motion of the wire 180, thereby reducing the likelihood of the wire 180 becoming tangled.

The positioning of the second opening 172 may vary. As exemplified in FIG. 6, a projection of the radial axis 163 of the shaft body 160 passes through the second opening 172. Providing the second opening 172 in the second portion 164 along the radial axis 163 of the shaft body 160 may reduce the likelihood of the wire 180 becoming tangled. For example, as shown in FIG. 6, the rotisserie 30 may be coupled along the longitudinal axis 161 of the shaft body 160, to allow the shaft body 160 to rotate along the same rotational axis as the rotisserie 30. Providing the second opening 172 in the radial direction may allow the wire 180 to pass into the channel 166 from within the cookbox 20, without interfering with the rotational axis of the shaft body 160 and/or the rotisserie 30.

In some embodiments, as exemplified in FIG. 10A, the channel 166 is also generally parallel with the longitudinal axis 161 of the shaft body 160. Accordingly, each of the first opening 170 and the second opening 172 may be generally parallel with the longitudinal axis 161 of the shaft body 160. In other words, each of the first opening 170, the second opening 172, and the channel 166 may be generally parallel to the axis of rotation 32 of the rotisserie 30 and shaft body 160. Aligning the first opening 170 and second opening 172 to be generally parallel to the longitudinal axis 161 of the shaft body 160 may reduce the likelihood of the wire 180 becoming entangled due to rotation of the rotisserie 30 and shaft body 160.

In some embodiments, the channel 166 may be a groove. For example, an exterior of the shaft body 160 may have a groove extending from interior of the cookbox 20 to exterior of the cookbox 20 for receiving the wire 180. The groove may receive the wire 180 and pass the wire 180 from the temperature sensor 140 to the base station 120, while securing the wire 180 in place to prevent entanglement due to rotation of the shaft body 160.

Referring to FIGS. 6 and 15, as exemplified, the second portion 164 is coupled to the rotisserie 30 within the cookbox 20. Accordingly, during use, when second portion 164 is coupled to the rotisserie 30 and the rotisserie 30 is rotated, the shaft body 160 rotates with the rotisserie 30. While the second portion 164 is exemplified as having a threaded connection to the rotisserie 30, it will be appreciated that the shaft body 160 may removably couple to the rotisserie 30 by any type of connection, including, but not limited to, threads, magnets, spring clips, tongue and groove, or any combination thereof.

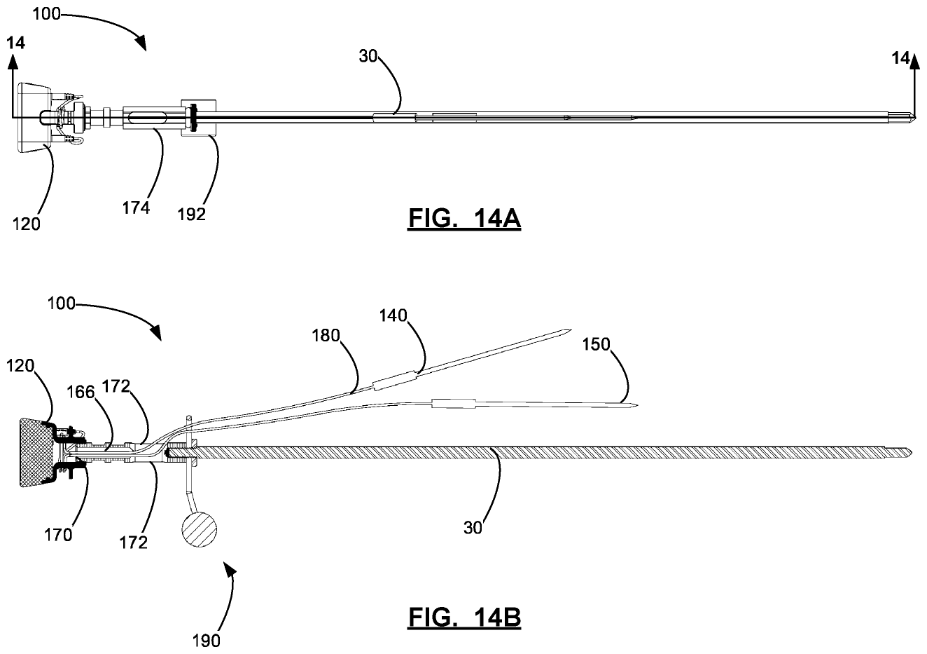

Referring to FIGS. 5B and 15, as exemplified, the temperature sensor 140 is electrically connected to the base station 120 by the wire 180, which passes through the channel 166 in the shaft body 160 to the base station 120 exterior to the cookbox 20. The temperature sensor 140 may be any device capable of measuring the temperature of food within the cookbox 20. As exemplified in FIGS. 2, 5B, and 14B the temperature sensor 140 may include a probe 142 that is sized and shaped to be inserted into the food.

During use, the probe 142 is inserted into the food to measure the temperature of the food. An advantage of using the probe 142 is that the interior temperature of the food may be measured. For example, when cooking meat, the meat should be cooked until the interior temperature of the meat reaches a safe temperature. Accordingly, the use of the probe 142 allows the interior temperature of the meat to be monitored so that the user knows when the food is safe to eat. Additionally, the temperature sensor 140 may be used to monitor the food to determine when the food reaches a desired interior temperature. For example, if a user desires a steak to be cooked to a particular interior temperature (e.g., medium rare), the user may use the temperature sensor probe 142 to monitor the interior temperature to ensure the food is cooked to the proper temperature.

It will be appreciated that the first opening 170 and the second opening 172 may be any size or shape capable of receiving the wire 180 and passing the wire 180 from the base station 120 to the temperature sensor 140 through the channel 166 in the shaft body 160. For example, the second opening 172 may be sized wide enough to pass the temperature sensor probe 142 from the first opening 170 exterior to the cookbox 20 to interior of the cookbox 20. In other words, the first and second opening 172 may be sized such that a rigid member such as the probe 142 may be passed through the channel 166 from exterior to the cookbox 20 to within the cookbox 20. It will be appreciated that, in some embodiments, the wire 180 may be passed from interior to the cookbox 20 through the channel 166 to exterior of the cookbox 20. For example, the end of the wire 180 that connects to the base station 120 may be fed through the channel 166. Accordingly, the size of the first opening 170 and the second opening 172 may be reduced if the probe 142 does not need to pass through the channel 166.

In some embodiments, the thermometer 100 may have a plurality of temperatures sensors. As exemplified in FIGS. 2, 5B, and 14B the thermometer 100 has a first temperature sensor 140 and a second temperature sensor 150. The first temperature sensor 140 measures a first temperature and the second temperature sensor 150 measures a second temperature. An advantage of this design is that two separate temperatures may be measured at different locations of the food. For example, if the user is cooking a piece of meat of varying thickness, the user may use the first temperature sensor 140 to measure the temperature of a thinner portion of the meat and the second temperature sensor 150 to measure a thicker portion of the meat. The user may then monitor the measured temperatures to ensure that, for example, the thicker portion is safely cooked without overcooking the thinner portion.

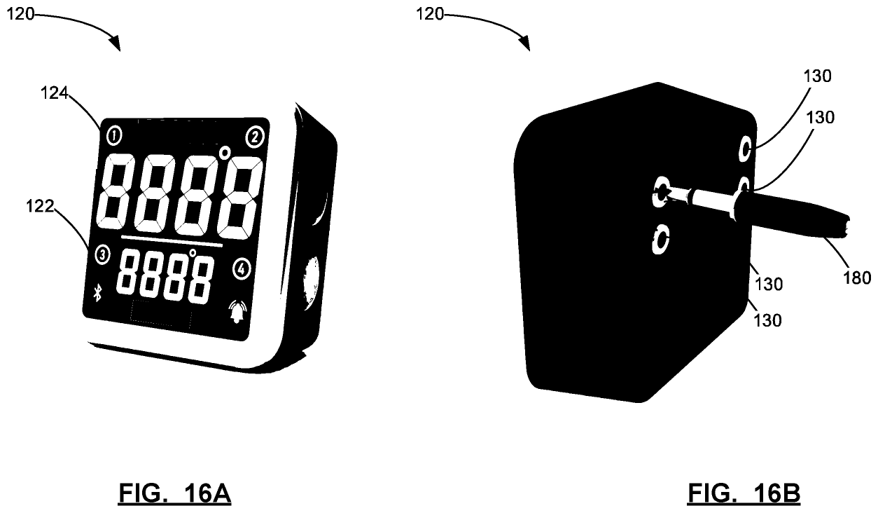

As exemplified in FIGS. 16A and 16B, the thermometer 100 may receive four temperature sensors. As shown, the base station 120 has four ports 130 for receiving four temperature sensors. Each temperature sensor respectively measures a different temperature of the food.

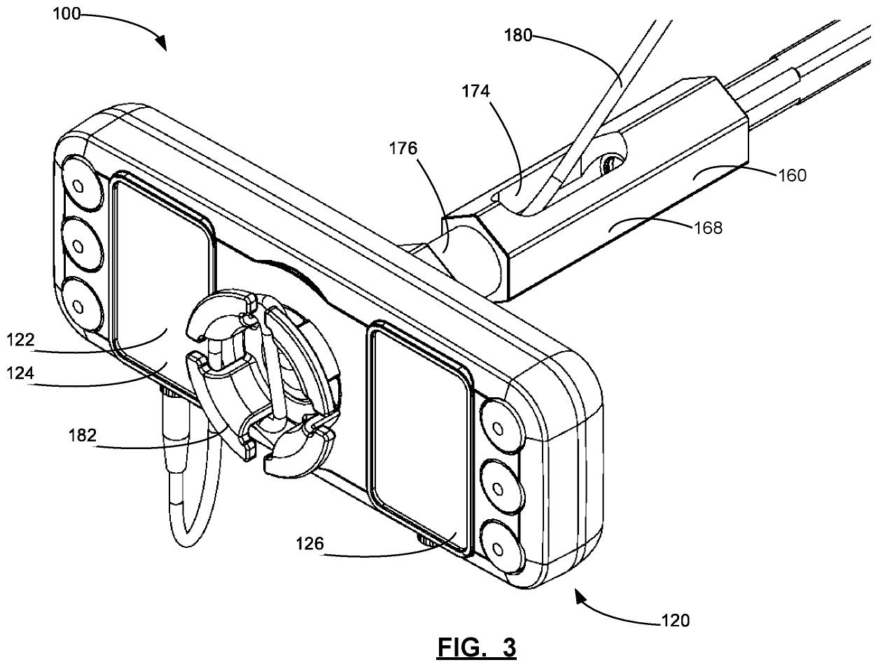

Referring to FIG. 3, as exemplified, the first portion 162 supports the base station 120 when the base station 120 is positioned on the shaft body 160. In some embodiments, the base station 120 may be removeably coupled to the first portion 162. For example, referring to FIG. 6, the base station 120 is removably coupled to the first portion 162 by a threaded connection. In other words, the base station 120 may be threaded onto the first portion 162 such that the base station 120 rotates with the rotation of the shaft body 160, which rotates due to the rotation of the rotisserie 30.

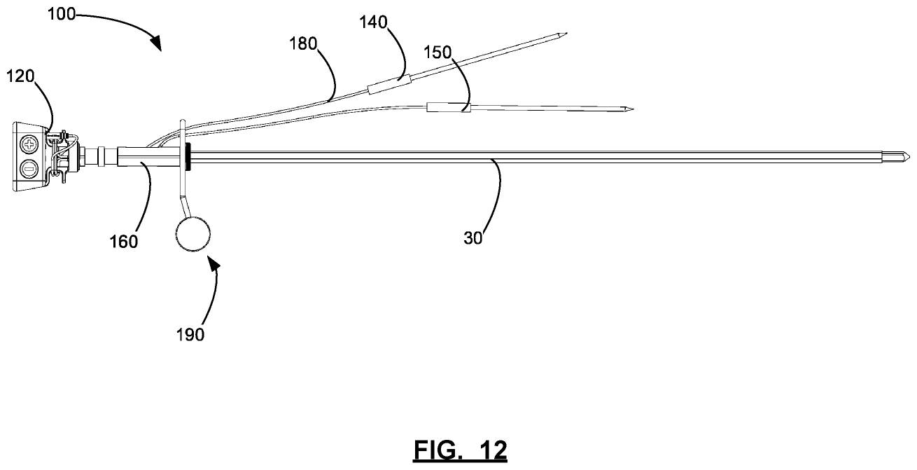

As exemplified in FIGS. 1-18, the base station 120 may have a readout 122. The readout displays the temperature measured by the temperature sensor 140. In some embodiments, as exemplified in FIG. 10A, the readout may be an analogue display. As exemplified in FIGS. 1-9, 10C, and 11-18 the readout may be a digital display.

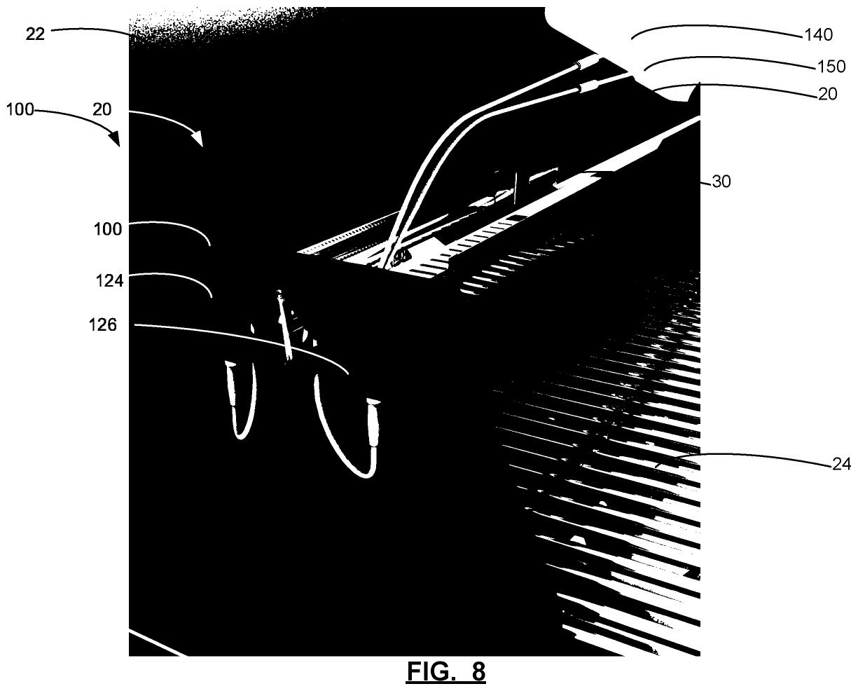

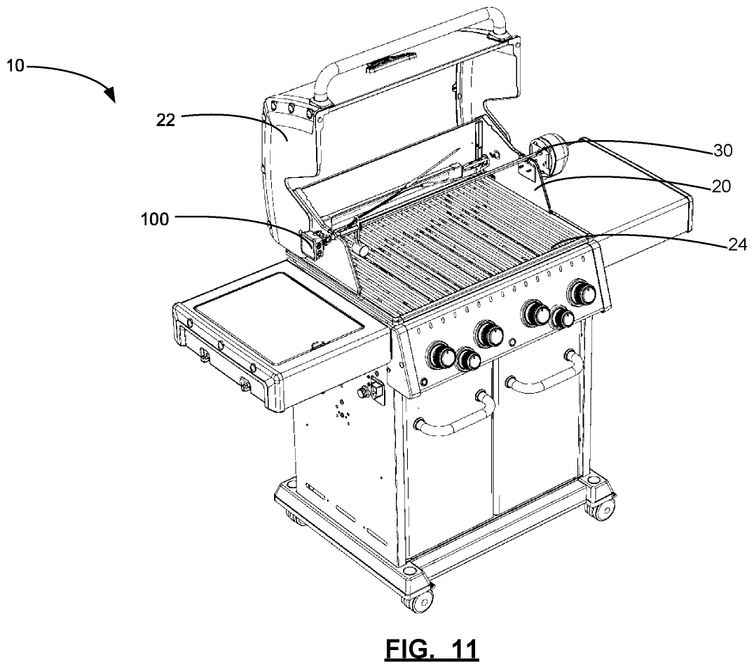

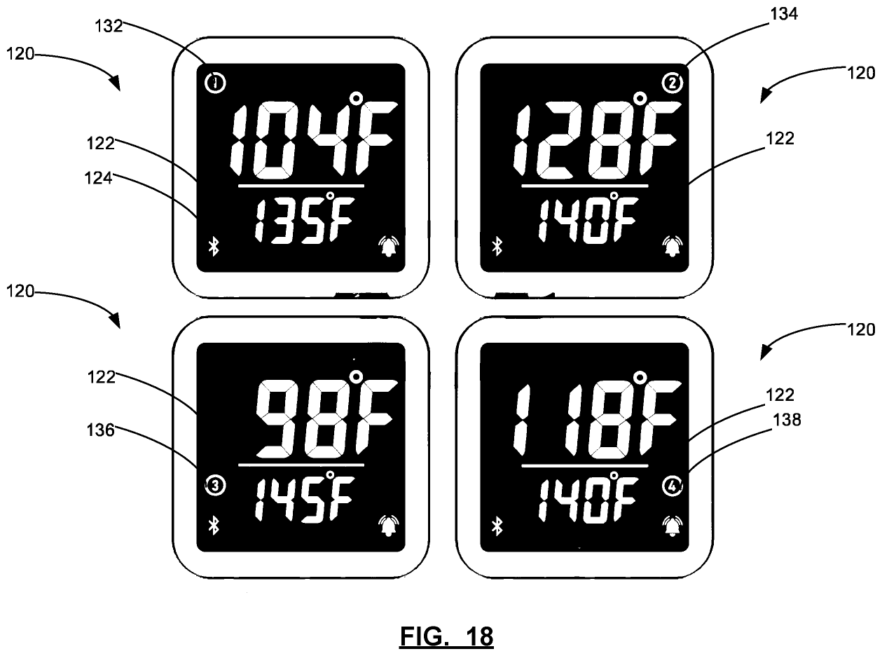

As mentioned previously, the thermometer 100 may include the first temperature sensor 140 and the second temperature sensor 150. As exemplified in FIGS. 3 and 8, in some embodiments, the readout 122 may have a first display 124 for displaying the first measured temperature and a second display 126 for displaying the second measured temperature. In some embodiments, there may be a plurality of temperature sensors 140 and a corresponding number of displays to display the measured temperature of each temperature sensor 140. In some embodiments, the display may be controlled to alternate between displaying the first measured temperature and the second measured temperature. In some embodiments, the readout may have a single display 124, as exemplified in FIGS. 11-18. Accordingly, the single display 124 may display both the first measured temperature and the second measured temperature or may alternate between displaying each measured temperature. For example, as exemplified in FIG. 18, the display 124 alternates between a first measured temperature 132, a second measured temperature 134, a third measured temperature 136, and a fourth measured temperature 138.

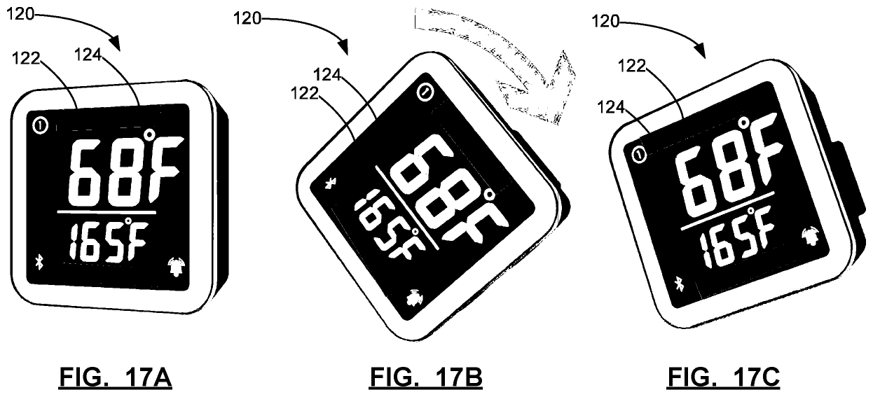

In some embodiments, the readout on the base station 120 may be self-leveling. For example, as shown in FIGS. 1-9, the base station 120 is coupled to the shaft body 160 such that rotation of the shaft body 160 causes rotation of the base station 120. Accordingly, the readout 122 displaying the measured temperature would also rotate with rotation of the shaft body 160. The readout 122 being self-leveling allows the readout 122 to automatically level itself to ensure that the displayed measured temperature remains readable for the user. To self-level, the readout 122 may be decoupled from the base station 120 such that rotation of the base station 120 and/or shaft body 160 does not cause rotation of the readout 122. In embodiments where the readout 122 is a digital display, the display may be digitally leveled. In other words, the display 122 may continuously self-level such that the displayed measured temperature remains in the same position despite rotation of the base station 120 and/or shaft body 160. For example, as the readout 122 rotates about 50 degrees from vertical, the text displayed on the readout 122 may rotate back 90 degrees (i.e., 90 degrees in the opposite direction of the rotation of the base station 120) so that the user is more easily able to continue reading the displayed text, as exemplified in FIGS. 17A-17C. To facilitate the self-leveling of the readout 122, the base station 120 may include, but is not limited to, an accelerometer, a gyroscope, and/or a level.

In some embodiments, the base station 120 may be supported by the first portion 162 in a manner that allows the shaft body 160 to rotate without causing rotation of the base station 120. For example, in some embodiments, the first portion 162 may have a rotary bearing that receives the base station 120 such that the shaft body 160, including the first portion 162, may rotate without causing rotation of the base station 120. An advantage of this design is that the base station 120 may remain level despite the rotation of the shaft body 160, thereby allowing the user to view the base station 120 more easily. In some embodiments, the base station 120 may be permanently coupled to the first portion 162 of the shaft body 160.

In some embodiments, the base station 120 may include a wireless communications module. The wireless communications module may facilitate wireless communication between the base station 120 and an external wireless communications device. For example, the wireless communications device may be, but is not limited to, a smart phone, a computer, a smart watch, a wearable, etc. The wireless communications module may communicate by one or more of, including, but not limited to, Bluetooth, Wi-Fi, RFID, or NFC.

The wireless communications module may be used to transmit the measured temperature from the base station 120 to the wireless communications device. Accordingly, a user may be able to remotely monitor the temperatures measured by the temperature sensor 140. An advantage of this design is that the user is able to leave the vicinity of the cookbox 20 while still ensuring that the food does not exceed a desired temperature. In some embodiments, the base station 120 may communicate an alert that the food has reached a desired temperature. The base station 120 may also monitor the derivative of the temperature of the food item to communicate to the wireless device that an abnormal temperature fluctuation has been determined, indicative of a flare up or flame within the cookbox 20.

In some embodiments, the base station 120 may not have a display, and may rely on the display of the wireless device to display the measured temperature to the user. In some embodiments the display of the base station 120 may be separate from the base station 120. For example, the base station 120 may be coupled to the rotisserie 30, external to the cookbox 20, and may wirelessly communicate with the display 122 that is positioned external to the cookbox 20. Accordingly, the signal between the base station 120 and the display 122 is not interfered with by the cookbox 20. The user may keep the separate display 122 next to the cookbox 20, or may move the display 122 a distance away from the cookbox 20, thereby allowing the user to monitor the temperature of the food without standing next to the cookbox 20.

As exemplified in FIG. 3, a winding member 182 may be located proximate the first portion 162 of the shaft body 160. The winding member 182 may be used to store at least a portion of the wire 180. Storing at least a portion of the wire 180 may allow the user to wind up the excess length of wire 180 between the first opening 170 and the base station 120, to reduce the likelihood of the excess wire 180 becoming tangled.

In some embodiments, the wire 180 received by the channel 166 may be an internal circuit. The circuit may be connected to a first port located in the first portion 162 of the shaft body 160 and to a second port located in the second portion 164 of the shaft body 160. The first port may be electrically connectable to the base station 120 and the second port may be electrically connectable to the temperature sensor 140. For example, there may be a second wire that electrically connects the base station 120 to the first port and a third wire that electrically connects the temperature sensor 140 to the second port. An advantage of this design is that different temperature sensors and/or base stations may be used with the shaft body 160. Additionally, the internal circuit may be more easily insulated to protect the circuitry from heat damage. Further, the internal circuit would not be subject to tangling and may reduce the likelihood of the second wire and/or third wire tangling.

As exemplified in FIGS. 11-15, the thermometer 100 may include a counterweight system 190. The counterweight system 190 includes a weight 192, an attachment 194, and a lock 196. The counterweight system 190 may be used to adjust the rotational profile of the thermometer 100 on the rotisserie 30 to account for eccentricity provided by food attached to the rotisserie 30. The counterweight system 190 may be adjustable. As exemplified in FIGS. 11-15, the lock 196 may be loosened to allow the attachment 194 to be moved up or down on the rotisserie 30, thereby changing the eccentricity of the rotation of the rotisserie 30. Once the attachment 194 is in the proper position, the lock 196 may be tightened to secure the attachment 194 in place.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants, modifications, and equivalents may be made without departing from the scope of the invention as defined in the claims appended hereto. The scope of the claims should not be limited by the preferred embodiments and examples but should be given the broadest interpretation consistent with the description as a whole.

1.-24. (canceled)

25. A thermometer for a rotisserie, the thermometer comprising:
a temperature sensor for measuring a temperature of food in a cookbox;
a base station for receiving the measured temperature of the food from the temperature sensor; and
a rotatable shaft body having a first portion for supporting the base station exterior to the cookbox and a second portion receivable within the cookbox and removably couplable to the food,
the rotatable shaft body defining a channel passing between the first portion and the second portion for receiving a temperature sensor wire therein such that the temperature sensor in the cookbox can be electrically coupled to the base station; and
wherein when the second portion is coupled to the food the rotatable shaft body rotates with rotation of the food along an axis of rotation.

26. The thermometer of claim 25, wherein at least a portion of the channel is enclosed.

27. The thermometer of claim 26, wherein the rotatable shaft body has a collar and the collar encloses the enclosed portion of the channel.

28. The thermometer of claim 25, wherein the first portion has a first opening for receiving the temperature sensor wire, the first opening being connected to the channel.

29. The thermometer of claim 28, wherein the rotatable shaft body has a longitudinal axis and a projection of the longitudinal axis passes through the first opening.

30. The thermometer of claim 29, wherein the longitudinal axis of the rotatable shaft body is parallel to the axis of rotation of the food.

31. The thermometer of claim 25, wherein the second portion has a second opening for receiving the temperature sensor wire, the second opening being connected to the channel.

32. The thermometer of claim 31, wherein the rotatable shaft body has a longitudinal axis and a radial axis that is perpendicular to the longitudinal axis and a projection of the radial axis passes through the second opening.

33. The thermometer of claim 32, wherein the longitudinal axis of the rotatable shaft body is parallel to the axis of rotation of the food.

34. The thermometer of claim 25, wherein the second portion has two radially opposed second openings for receiving the temperature sensor wire, the two second openings being connected to the channel.

35. The thermometer of claim 25, wherein when the temperature sensor wire is positioned in the channel and the food is rotated, the temperature sensor wire remains positioned within the channel.

36. The thermometer of claim 25, wherein the rotatable shaft body is removable coupled to the food by threads, magnets, spring clips, or tongue and groove.

37. The thermometer of claim 25, further comprising a winding member located proximate the first portion for storing at least a portion of the temperature sensor wire.

38. The thermometer of claim 25, wherein the base station has a readout for displaying the measured temperature of the food.

39. The thermometer of claim 25, wherein the base station is removably coupled to the first portion.

40. The thermometer of claim 25, wherein the base station is stationary during rotation of the rotatable shaft body.

41. The thermometer of claim 25, wherein the base station further comprises a wireless communications module for communicating with a wireless communications device.

42. The thermometer of claim 38, wherein the temperature sensor is a first temperature sensor and the measured temperature is a first measured temperature and the thermometer further comprises at least a second temperature sensor for measuring a second temperature of the food.

43. The thermometer of claim 42, wherein the readout display has a first display for displaying the first measured temperature and a second display for displaying the second measured temperature.

44. The thermometer of claim 42, wherein the thermometer further comprises a third temperature sensor for measuring a third temperature of the food and a fourth temperature sensor for measuring a fourth temperature of the food.

45. The thermometer of claim 44, wherein the readout display alternately displays one or more of the first temperature, the second temperature, the third temperature, and the fourth temperature.

46. The thermometer of claim 25, wherein the thermometer further comprises a counterweight system to adjust the rotation of the rotatable shaft body, the counterweight system including a weight, an attachment and a lock.

47. The thermometer of claim 25, wherein the temperature sensor is a probe that is sized and shaped to be inserted into the food.

48. A shaft adaptor for a cookbox rotisserie, the shaft adaptor comprising:
a rotatable shaft body having a first portion for supporting a base station exterior to the cookbox and a second portion receivable within the cookbox and removably couplable to food in the cookbox,
wherein the rotatable shaft body defines a channel passing between the first portion and the second portion for receiving a temperature sensor wire therein such that a temperature sensor in the cookbox can be electrically coupled to the base station; and
wherein when the second portion is coupled to the food, the rotatable shaft body rotates with the rotation of the food.
